(19) United States
(12) Patent Application Publication
(10) Pub. No.: US 2007/0199233 A1
(43) Pub. Date: Aug. 30, 2007

(54) Fishing Lure

(75) Inventor: Christopher Lyndon Higgin, Arcadia (AU)

Correspondence Address: BROOKS KUSHMAN P.C., 1000 TOWN CENTER, TWENTY-SECOND FLOOR, SOUTHFIELD, MI, 48075, US

(73) Assignee: ABACUS (C.I.) LIMITED AS TRUSTEE OF THE BAYVIEW TRUST, Jersey (GB)

(21) Appl. No.: 11/569,693

(22) PCT Filed: May 27, 2005
(86) PCT No.: PCT/AU05/00746

§ 371 Date: Nov. 28, 2006

(30) Foreign Application Priority Data
May 28, 2004 (AU) 2004902847

(51) Int. Cl. A01K 85/00; A01K 85/01

(52) U.S. Cl. 43/42.09; 43/42.32; 43/17.6; 43/42.31; 43/42.36

(57) ABSTRACT

A fishing lure system consisting of lure bodies (30) of one or more parts and covered with at least one replaceable decorated plastic sleeve or cover (400) which is attached to the lure body (30) by adhesive means and/or shrunk by application of heat or other means to conform to the shape of the lure body (30).

### FIELD OFF THE INVENTION

The present invention relates to fishing lures

### BACKGROUND TO THE INVENTION

Any discussion of the prior art throughout the specification should in no way be considered as an admission that such prior art is widely known or forms part of common general knowledge in the field.

Prior art fishing lures are numerous and mainly consist of some form of soft or hard shapes of timber or moulded plastic which are painted or otherwise decorated to a design which is deemed suitable to attract fish.

Such lures are quite expensive considering the need to individually paint each lure shape and the often limited use of lures which anglers experience due to damage caused by fish bites or other scraping against rough surfaces of rocks or snags which at least partly destroy the decorative finish and the wide variation in lures which an angler needs to carry to have available a lure of the colour or shape or other feature suitable for particular fishing conditions or fish species or locations.

It is an object of the present invention to overcome or ameliorate at least one of the disadvantages of the prior art, or to provide a useful alternative.

### SUMMARY OF THE INVENTION

The present invention is intended to at least reduce the cost of having a wide range of fishing lures by at least the use of replaceable decorative covers which enable the angler to renew or change the appearance of lures by applying a relatively inexpensive decorated plastic cover to a lure body.

One aspect of the present invention is a fishing lure consisting of at least one lure body element of any suitable material such as plastic or timber and having attachment devices such as:

a) open or closed rings or eyelets;

b) swivels;

c) clips

to which may be attached one or more of:
(i) fishing lines and hooks;
(ii) devices to modify way in which the lure moves and/or the depth at which the lure moves in water;
(iii) a light source;
(iv) a device of reflective material which spins or twists or moves on any axis to reflect light;
(v) a device such as a rattle to emit noise as the lure moves;
(vi) other lure body elements
   and having at least one decorative cover or cover piece of decorated plastic film or decorated metallic foil or combination thereof which is affixed to the said lure body.

Another aspect of the present invention is a lure body or lure body element which is formed by moulding in plastic a desired shape and including within the said plastic shape a portion of one or more attachment devices such that the portion of the said attachment device held within the said plastic shape affixes the said attachment device to the said lure body element.

Another aspect of the present invention is a lure body or lure body element which is formed by moulding in plastic a desired shape and including within the said plastic shape at least portion of an assembly of attachment devices such that the portion of the said assembly of attachment devices included within the said plastic shape affixes the said assembly of attachment devices to the said lure body element.

Another aspect of the present invention is a lure body or lure body element which has formed in it one or more of an opening or channel or slit which shaped to receive a device including a device located at the front of the lure to cause the lure to exhibit certain characteristics such as to travel at a desired depth when trolled and/or to move in a desired way such as an erratic movement or a movement mimicking a wounded bait.

Another aspect of the present invention is one or more in combination of a cover or cover piece for a lure body and said covers being produced in any combination of the following,
I.) as separate covers or cover pieces suitable for application to a lure including having adhesive on one or more surfaces of said cover;
II.) as covers or cover pieces printed or transferred onto a continuous flat strip said strip being rolled or folded for ease of transport or storage and said elements including elements which may have slits or openings in the plastic material and including having adhesive on one or more surfaces of said cover and a convenient cutting space between discrete cover pieces;
III.) as covers or cover pieces printed or transferred onto a continuous flat strip which strip may be further formed into a tube by known means including adhesive means on one or more surfaces of said cover and each cover being separated by a convenient cutting space between discrete cover pieces. The said tube may be rolled or folded for ease of transport or storage;
   and consisting of materials including highly reflective materials. Including but not limited to and in any combination of:
1) aluminum foil or coloured aluminum;
2) plastic film with our without an included colourant material and including plastic film which may be processed so as to shrink in one or more axis under application of heat;
3) metalised plastic film being plastic film which is coated with material or has within it light reflective material;
4) plastic film including coloured or tinted plastic film having printed designs of any shape or colour;
5) plastic or plastic film having on it by printing or other image or foil transfer means and/or integrally formed on it or in it any design or shape representing a fish or crustacean or any creature or thing which is attractive by virtue of its shape and/or design and/or colouring to any creature living in the sea or in freshwater and/or represents or is a simile of potential prey for any creature living in the sea or in freshwater;
6) cover material such plastic film or foil which does not shrink or shrinks only minimally upon application of heat and said cover material being slit or shaped so that a lure body cover may be formed of such material such that the cover has an unslit section which is applied to cover the widest cross sectional area of the lure body and the slits which preferably form the slit portions of the said cover into tapered strips which are narrower at the extremities furthest from the unslit portion to allow the cover material or at least the strips formed by the slits to more s easily lie or adopt an orientation being flat against the surface of a lure body and having at least a section of the cover overlaid with for example one or more mostly clear tubular covers or sleeves which are then shrunk by application of beat to cause the said a mostly clear covers or sleeves to conform tightly to the lure body thereby holding the slit cover or undercover in place. The said undercover with slits may also or instead of some of the slits have a shaped tail section of a dimension preferably at least similar to the height of the widest cross sectional area and the said tail section may have one or more stiffening pieces of material affixed or the material forming the tail may be thicker to keep the tail section in shape and promote movement of the tail by water currents acting on the stiffened tail section.

### BRIEF DESCRIPTION OF DRAWINGS

Preferred embodiments of the invention will now be described, by way of example only, with reference to the accompanying drawings in which:

FIG. 1 depicts a sub frame over which a plastic lure body is moulded leaving exposed only attachment devices 12b, 12c and 12d and external lure element 20A. In another embodiment of the present invention separate attachment devices 12A may be unconnected to other attachment devices and are separately partly encased and anchored within the plastic matrix forming the lure body. In this preferred embodiment the said sub frame is a wire rig or combination of metal and/or other robust material such as Kevlar and constructed to form and/or with separately formed mounting points such as rings or eyelets 12B at the nose of the lure, 12C centrally and 12D at the tail of the lure to which may be attached fishing line and one or more hooks and or one or more additional lure elements

FIG. 2 shows an uncovered basic lure body shape 30 consisting of one or more parts formed by encasing the said sub-frame Or sub-frames or two or more joined frames in any suitable material such as moulded plastic and leaving exposed attachment devices 12B, 12C and 12D and said lure body formed as a desired shape such as to mimic the shape of one or more species of bait fish or bait facsimile and or be of a shape or shapes that will exhibit desirable characteristics when being trolled.

FIG. 2A is a lure body shown without a cover and consisting of more than one piece whereby the 2 or more pieces are articulated allowing the parts to move relative to each other when the lure is moved through water and thus simulating bait swimming motion

FIG. 3 depicts a lure cover or sleeve 400 of any known material coloured and/or decorated and/or highly reflective such as a plastic preferably in the form of a tube which may be slipped over the said basic body shape and the said sleeve is shrunk by application of heat or glued or otherwise affixed so that it follows the shape of and is firmly secured at least at the free edges to the said lure body or lure body pieces. The cover or sleeve may be decoratively printed plastic film, such plastic film for example being of a type that has a highly reflective finish of one or more colours including luminous colours of foil with a holographic effect displaying a highly reflective surface having changing colours according to changes in the aspect of the lures. The said cover or sleeve may have a printed design having fish like features

FIG. 4 shows the cover or sleeve referred to in FIG. 3 having been shrunk into position on the lure body shape by application of heat or other means

FIG. 4A shows a sectional view of a lure body 30 depicting a slot to receive an externally mounted device.

FIG. 5 shows part of a flat strip of cover material 500 having free longitudinal edges 505 and 510 and cutting space 520 which separates and is between each cover piece on the said strip

FIG. 6 shows a lure body 30 without cover in a normal orientation.

FIG. 7 shows the lure body of FIG. 6 viewed from underneath and having a channel or recess 36 extending substantially between the front and back of the lure body. In other embodiments the channel 36 may be interrupted or extend on one or other sides of attachment device 12C or bifurcate and pass on both sides of attachment device 12C

FIG. 8 shows cross section BB of lure body 30 shown in FIG. 7 and showing channel 36 which is formed with an opening slightly smaller than the widest cross sectional dimension deeper in the channel.

FIG. 9 shows a partial perspective view of a cover consisting of tubular cover pieces 401 and 402 which have beep separated from a continuous tubular shape stored on a roll or folded or stored by some other means (storage means not shown)

FIG. 10 shows as an example part of a continuous strip of bait shapes 600 with features printed on a highly reflective material or on a transparent film which cover the said highly reflective material.

### DETAILED DESCRIPTION OF PREFERRED EMBODIMENTS

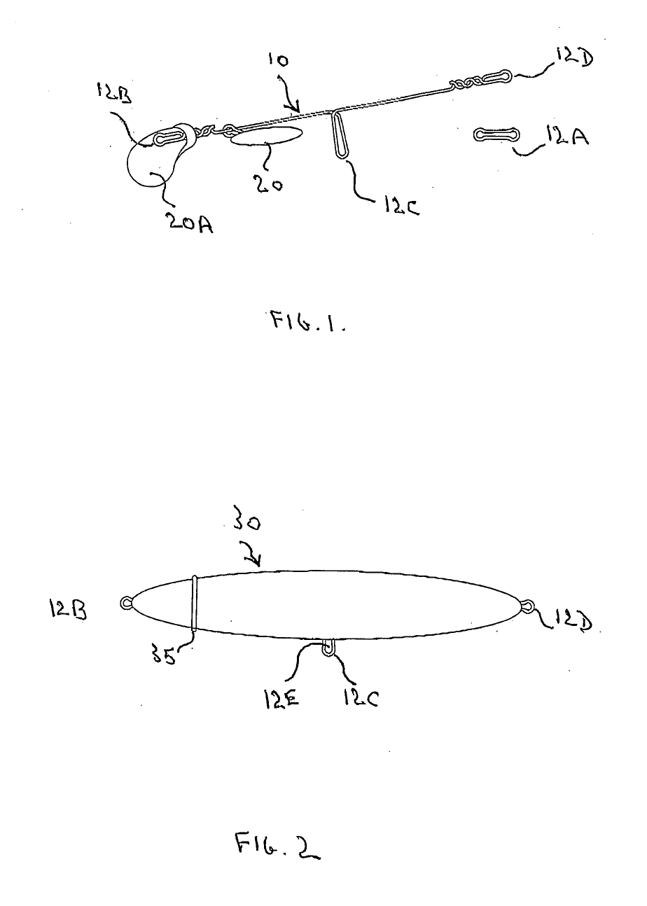

FIG. 1 illustrates an attachment assembly or sub frame over which a plastic lure body is moulded leaving only attachment devices 12 or external lure elements 20A exposed. In this preferred embodiment the said sub frame is a wire rig or combination of metal and/or other robust material such as Kevlar and constructed to form and/or with separately formed:

mounting points such as rings or eyelets 12B at the nose of the lure, 12C and 12D at the tail of the lure to which may be attached fishing line and one or more hooks and or one or more additional lure elements;

one or more additional devices 20 within the plastic matrix of a lure body or a cavity created within the said lure body such as a noise making device or rattle and/or weight and/or buoyancy device. Said additional devices may be advantageously incorporated into the sub frame at the time of manufacture;

one or more devices 20A mounted externally to the lure body to cause the lure to exhibit certain characteristics such as to travel at a desired depth when trolled and/or to move in a desired way such as an erratic movement or a movement mimicking a wounded bait

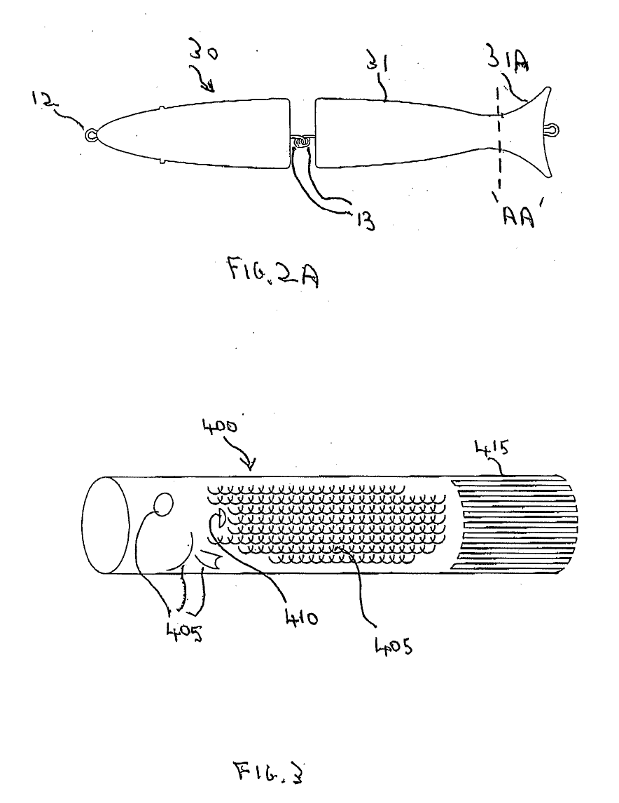

FIG. 2 shows an uncovered basic lure body shape 30 consisting of one or more parts formed by encasing the said sub-frame or sub-frames or two or more joined frames in any suitable material such as moulded plastic and leaving exposed attachment devices 12B, 12C and 12D and said lure body formed as a desired shape such as to mimic the shape of one or more species of bait fish or bait facsimile and or be of a shape or shapes that will exhibit desirable characteristics when being trolled and such shape for example may have one or more fins or projections or devices either integrally moulded with the encasing of the sub frame or appended to either the said sub frame or lure body or removably and/or adjustably mounted on the lure body to cause the lure to exhibit one or more certain characteristics such as to travel at a desired depth when trolled and/or to move in a desired way such as an erratic movement or a movement mimicking a wounded bait

The said lure body may also have:
(not shown) an aperture or slit or channel shaped to receive said fins or projections together with a locking device to retain said fins or projections;
raised features such a ridge 35 which the cover or sleeve may shrink around or abut to so as to assist in retaining the said cover on the said lure body during use.

FIG. 2A is a lure body 30 shown without a cover and said lure body consisting of more than one lure body portion said portions consisting at least a first portion and a second portion 31 and said portions having more than one mounting points 12 and 13. Said mounting points 13 are located externally of a lure body portion but inside the overall skin or shape of the overall bait like shape of the lure body. Said various items as referred to in the description of FIG. 1 may be attached to any of said mounting points and in this embodiment mounting point. 13 are at least or are in addition connected together by known means to form an articulated joining so that said lure body portions may move independently of each other. A decorative cover or sleeve may be placed over the lure body shape without interfering with said mounting points 13. The said relative movement of the said lure body portions when the lure is moved through water simulating bait swimming motion and (not shown) enhancing reflection of light from any reflective cover or surface of the lure. The rear portion of the lure 31 has a shaped tail section over which may be affixed the tail portion of a lure body cover said tail portion may instead be a separate piece divided at the dotted line ‘AA’ and attached by mounting points 13 in an articulated joining.

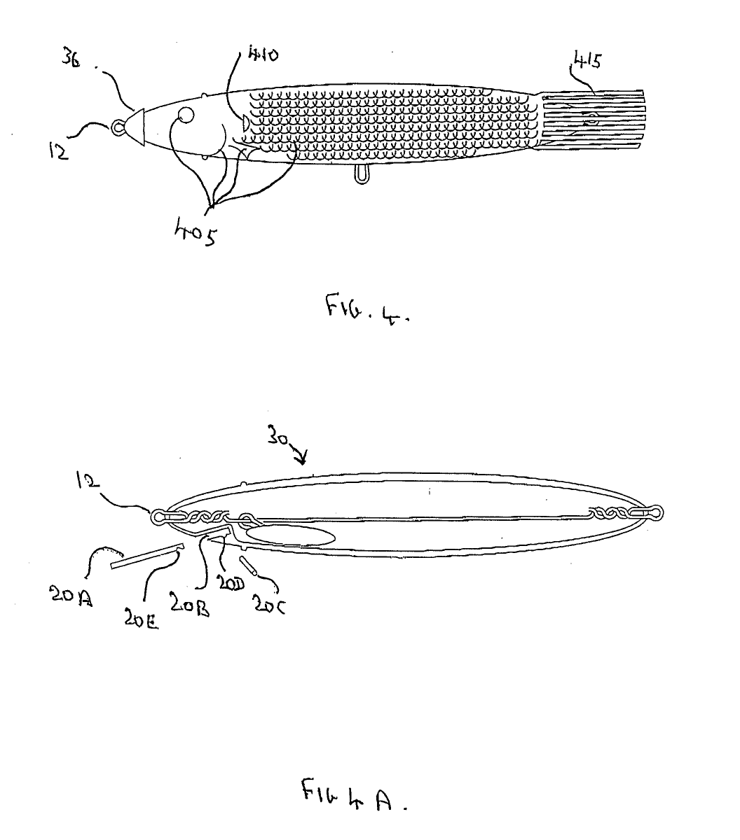

FIG. 3 depicts a lure cover or sleeve 400 of any known material coloured and/or decorated and/or highly reflective such as a plastic preferably in the form of a tube which may be slipped over the said basic body shape and the said sleeve is shrunk by application of heat or glued or otherwise affixed so that it follows the shape of and is firmly secured at least at the free edges to the said lure body or lure body pieces. The cover or sleeve may be decoratively printed plastic film such plastic film for example being of a type that has a highly reflective finish of one or more colours including luminous colours of foil with a holographic effect displaying a highly reflective surface having changing colours according to changes in the aspect of the lures. The said cover or sleeve may have a printed design having fish like features 405 for example in the form of or a facsimile of a fish species consistent with the shape and size of the said lure body shape or in some other form which is attractive to fish and when the sleeve is to be shrunk onto the said basic body shape the decorative printing may be designed to allow for the shrinkage so that the said decorative printing when shrunk will assume the desired appearance. Covers or sleeves may also have one or more openings 410 to allow water to flow through between the covers or underneath the cover so as to cause at least one of the cover surfaces to change aspect and reflect light in different directions as water flows or is urged through the said opening and underneath the said cover.

FIG. 4 shows the cover or sleeve referred to in FIG. 3 having been shrunk into position on the lure body shape by application of heat or other means. After application of the sleeve a nose piece 36 moulded of plastic or metal may if necessary be placed over the nose of the lure and or a small amount of glue may be applied to cover any gap or opening in the leading end of the heat shrunk material so as to prevent water under pressure of trolling infiltrating beneath the leading edge of said sleeve and delaminating the said sleeve from the underlying body of the lure. The cover or sleeve may be longer than the said lure body shape and may in part consist of thin strips 415 which when the lure is trolled through water will flex and move reflecting light and colour in a manner attractive to fish. More than one reflective coloured covers or sleeves may be applied including a top sleeve which may be transparent and/or having decorative colouring or printing 405 depicting one or more of the characteristics of the exterior appearance of any bait and applied over the other covers or sleeves. The overhanging trailing portions 415 of any of the applied the covers or sleeves may be in the form of thin strips which will advantageously flex when moving through the water and in moving reflecting light and the colours of each of the applied covers or sleeves in a manner suitable to be attractive to fish. In another embodiment the cover or sleeve portion 415 may instead be in the form of a tail which would be shrunk onto a lure body tail portion 31A shown in FIG. 2A.

FIG. 4A shows a sectional view of a lure body 30 having attachment means 12 and a slot 20B said slot having a transverse semi-circular channel 20D the words semi-circular referring to the cross sectional shape of the said channel. Said slot and channel formed in the said body to receive and lockingly locate device 20A which also has a semi-circular channel 20E which co operates with said semi-circular channel 201 to form a circular orifice to receive pin 20C which locks device 20A into position. Said device 20A having a similar purposes to device 20A referred to in FIG. 1 and devices elsewhere in this specification

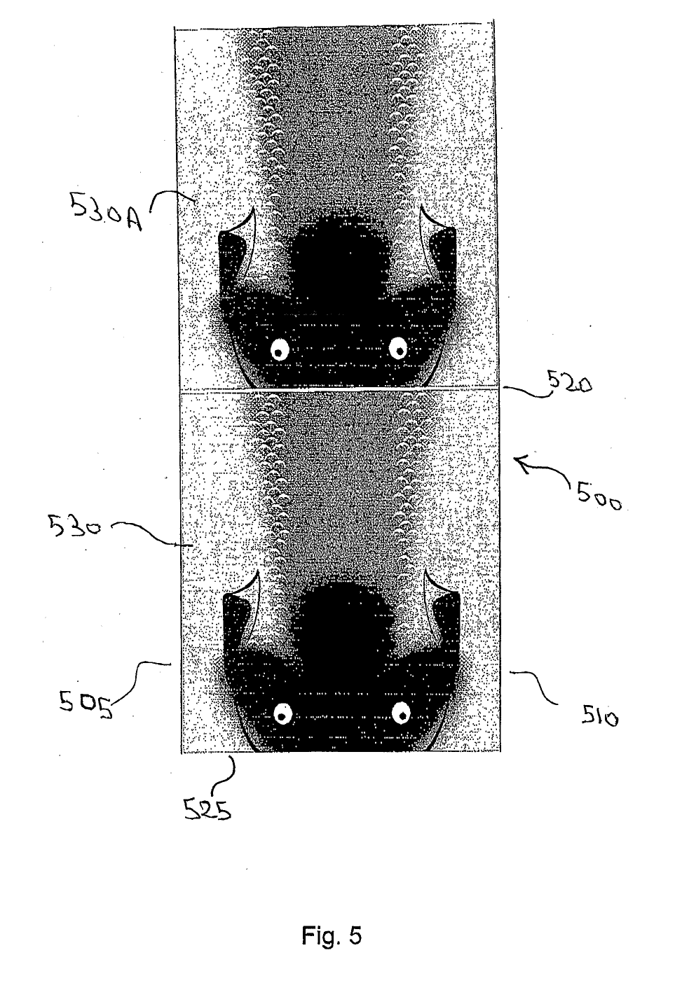

FIG. 5 shows part of a flat strip of cover material 500 having free longitudinal edges 505 and 510 and cutting space 520 which separates and is between each cover piece on the said strip. Edges 505 and/or 510 may have adhesive such applied during manufacture and an adhesive protectant strip or layer (not shown) may be applied to prevent the adhesive adhering to the adjacent material when the strip is rolled or folded for transport or storage. To create a cover for a lure body the first cover element 530 having leading free edge 525 is separated from the said flat strip of cover material 500 by cutting at separation line 520 and the separated cover element 530 is then formed around a lure body such as shown in FIG. 2 with free edges 505 and 510 abutting attachment device 12C (referring to FIG. 2) or overlapping one another and requiring a small slit to be made to accommodate attachment device 12C and surfaces adjacent to said free edges 505 and 510 being affixed to the lure body by adhesive means such as hot melt glue and upon setting of said adhesive a heat source is applied to the cover or sleeve to shrink the cover to adopt the shape of the lure body. If desired and the cover is of sufficient length to overlap the attachment device 12D at the tail of the lure body then:

in another embodiment of the present invention shaped separate tail shaped piece of stiff material is inserted into the said overlapping portion of the cover or sleeve and the said cover or sleeve is then shrunk onto the said shaped tail piece of stiff material to form a tail portion which can move at least partly independently of the lure body by the cover material flexing;

in another embodiment heat is not directed at the said overlapping portion and the said overlapping portion is not shrunk and the said overlapping portion maybe slit into strips;

and said strips or shaped tail portion which when the lure is trolled through water will flex and move reflecting light and colour in a manner attractive to fish

Said flat strip of cover material may also be formed into a tube by affixing to each other by known means, the corresponding surfaces adjacent to free longitudinal edges 505 and 510, the means of creating a cover for a lure body using a strip of tubular cover material is as for a flat strip of cover material except for the need to make a slit to accommodate attachment device 12C (referring to FIG. 2) or if no slit is made then to puncture the cover material that shrinks around and overs the attachment aperture 12E (again referring to FIG. 2).

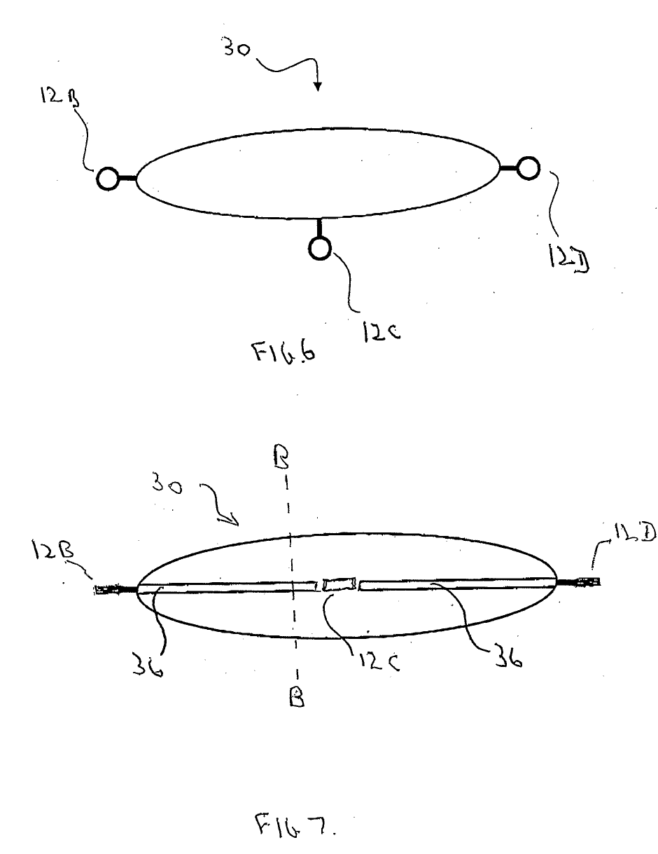

FIG. 6 shows a lure body 30 without cover in a normal orientation.

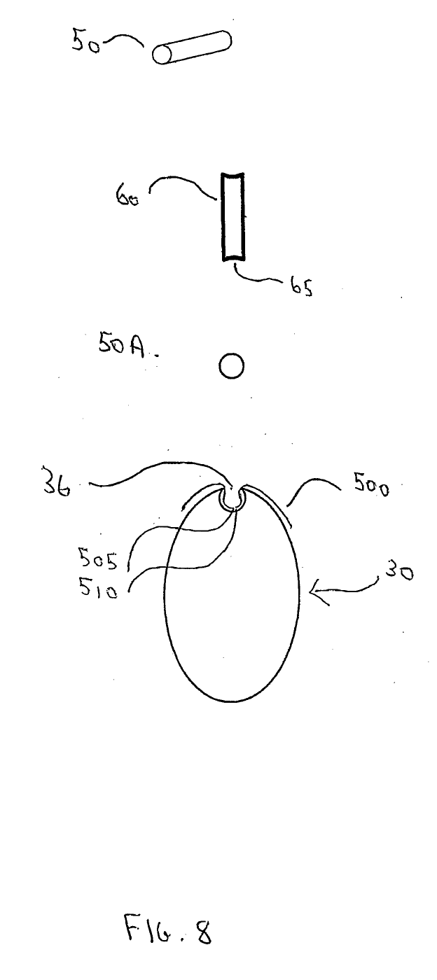

FIG. 7 shows the lure body of FIG. 6 viewed from underneath and having a channel or recess 36 extending substantially between the front and back of the lure body. In other embodiments the channel 36 may be interrupted or extend on one or other sides of attachment device 12C or bifurcate and pass on both sides of attachment device 12C

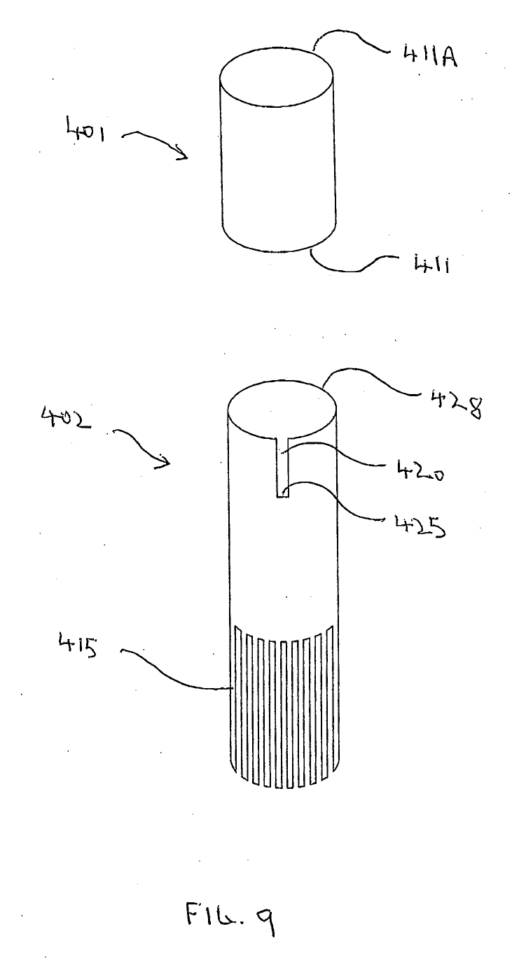

FIG. 8 shows cross section BB of lure body 30 shown in FIG. 7 and showing channel 36 which is formed with an opening slightly smaller than the widest cross sectional dimension deeper in the channel. In applying a flat strip or non tubular cover to a lure body free edges or at least the portions adjacent to said free edges of cover 500 (shown partially in cross section) are inserted into channel 36 and said cover is then held in place in said channel by application of a compressible cylindrical strip 50 of cross section 50A and said cross sectional area of 50A is slightly larger than the cross sectional area of channel 36 and application of said compressible strip 50 is effected by a tool shape 60 which has a concave surface 65 which concave surface is pressed against convex surface of said compressible strip 50 to insert said compressible strip 50 into channel 36. additionally if free edges 505 and 510 are in an overlapping position then adhesive may be applied to the upper surface of the free edge first inserted into said channel 36 and the other free edge then placed over the said adhesive coated free edge aid the said compressible strip 50 is then inserted into channel 36. Concave surface 65 may be formed as the perimeter of an annular shape.

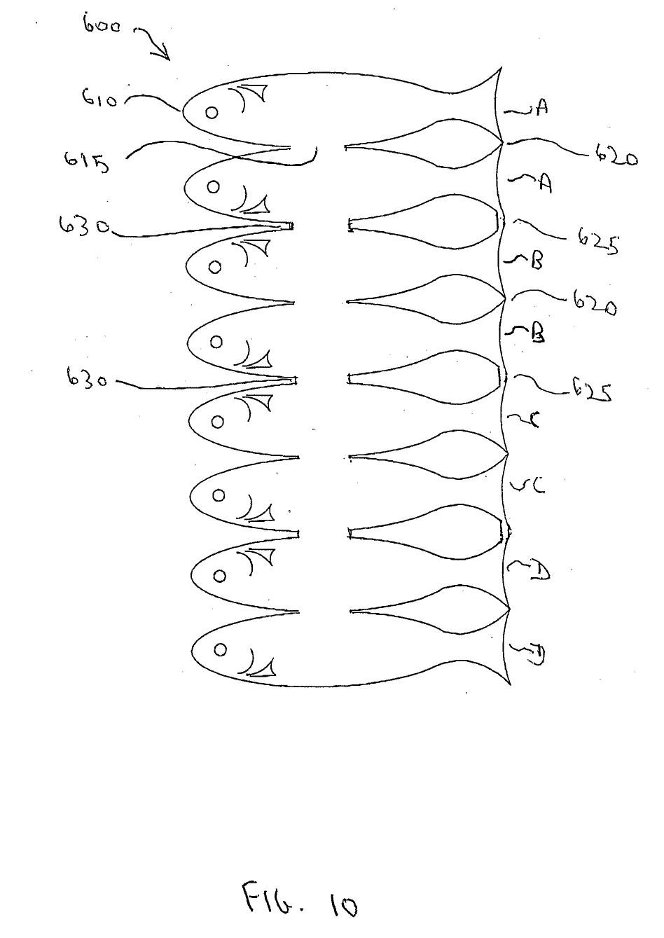

FIG. 9 shows a partial perspective view of a cover consisting of tubular cover pieces 401 and 402 which have been separated from a continuous tubular shape stored on a roll to cover a lure body 30 (referring to FIG. 6) where attachment device 12D is at the rear of the said lure body and cover piece 402 which covers the rear of said lure body has slit or opening 420 said slit or opening having rear wall 425 and upon assembly cover piece 402 onto said lure body rear wall 425 is positioned to abut or be in close proximity to attachment device 12C so that leading free edges 428 are forward of attachment device 12C and cover piece 401 is assembled so trailing free edge 411 passes over the said leading free edge 428 of cover piece 402 and abuts or is in close proximity to attachment device 12C. Slit or opening 420 and leading free edges 428 of cover piece 402 are thereby covered by cover piece 401 and upon shrinking of cover pieces by application of heat or other means both cover pieces are held in position on said lure body. Slits 415 and slit or opening 420 are advantageously formed in the cover material whilst it is in strip form prior to being formed into a tubular structure.

In circumstances where hooks remain attached to attachment devices especially a central attachment device such as 12C (referring to FIG. 2) a tubular late cover consisting of 2 tubular cover pieces can be advantageously used without removing said hooks.

FIG. 10 shows as al example part of a continuous strip of bait shapes 600 with bait shapes 610 printed and cut-out in pairs A A B B on a highly reflective material not prone to shrink on application of heat. Said bait shape pairs are connected together at point 620 at the tail and point 615 at a dorsal location. Each pair of bait shapes is joined to the next of said pairs of bait shapes by connecting piece 625 at the tail and by connecting piece 630 at a dorsal location. All edges other than the said joining pieces and joining points are free edges. Each pair of joined bait shapes is severed from the adjoining pair by severing joining pieces 625 and 630. The separated pair of bait shapes may then be folded at the joining points 620 and 615 and placed on a lure body such as that shown in FIG. 2A and a tubular cover sleeve made of transparent material which shrinks on application of heat and of similar shape to the cover pieces 401 and 402 shown in FIG. 9 but absent strips 415 is placed over the said bait shapes and heat applied to shrink cover pieces 401 and 402 bring said cover pieces 401 and 402 and the bait shapes underneath into close or tight proximity to lure body 30 (referring to FIG. 2A) thereby creating a an attractive and highly reflective bait simile.

1. A fishing lure; said lure comprising:
a body;
an outer covering;
wherein said outer covering is shrunk onto said body.

2. The fishing lure as claimed in claim 1 further comprising a frame to which said body is attached.

3. The fishing lure as claimed in claim 2 wherein said frame is formed from wire.

4. The fishing lure as claimed in claim 2 wherein said frame is formed from wire.

5. The fishing lure as claimed in claim 1 wherein the body is molded from a suitable plastics or rubber material.

6. The fishing lure as claimed in claim 1 wherein the body is shaped to mimic the shape of a bait for a fish.

7. The fishing lure as claimed in claim 1 wherein the body comprises more than one piece.

8. The fishing lure as claimed in claim 7 wherein the pieces are connected and articulated so as to allow movement relative to each other.

9. The fishing lure as claimed in claim 1 wherein the outer covering is decorated.

10. The fishing lure as claimed in claim 1 wherein the outer covering is formed from a heat shrinkable material.

11. The fishing lure as claimed in claim 1 wherein the outer covering is formed from a film.

12. The fishing lure as claimed in claim 1 wherein the outer covering is in the form of a sleeve which is passed over at least part of the body and then shrunk to conform to the body.

13. The fishing lure as claimed in claim 1 wherein said outer covering is in the form of a substantially flat sheet which is wrapped over said body.

14. The fishing lure as claimed in claim 13 wherein said body includes a channel or recess which receives a retaining member for retaining said outer covering on said body.

15. The fishing lure as claimed in claim 14 wherein free edges of said outer covering are located in said channel or recess and retained therein by said retaining member.

16. The fishing lure as claim in claim 15 wherein said retaining member is compressible.

17. The fishing lure as claimed in claim 14 wherein said channel or recess extends substantially between the front and rear of the lure body.

18. The fishing lure as claimed in claim 1 wherein the outer covering is formed from a light reflective material.

19. A method of making a fishing lure; said method comprising:
forming a body;
applying an outer covering to said body;
wherein said outer covering is shrunk onto said body.

20. The method of making a fishing lure as claimed in 19 wherein the frame is formed from wire.

21. The method of making a fishing lure as claimed in claim 19 wherein the body is molded from a suitable plastics or rubber material.

22. The method of making a fishing lure as claimed in claim 19 wherein the body is shaped to mimic the shape of a bait for a fish.

23. The method of making a fishing lure as claimed in claim 19 wherein the outer covering is decorated.

24. The method of making a fishing lure as claimed in claim 19 wherein the outer covering is formed from a heat shrinkable material and is shrunk onto the body by the application of heat.

25. The method of making a fishing lure as claimed in claim 19 wherein the outer covering is in the form of a sleeve which is passed over at least part of the body and then shrunk to conform to the body.

26. A cover for a fishing lure, said cover made from a shrinkable material.

27. The cover as claimed in claim 26 wherein the cover is made from a heat shrinkable material.

28. The cover as claimed in claim 26 wherein the cover is formed from a film.

29. The cover as claimed in claim 26 wherein the cover is on the form of a sleeve which is passed over at least part of a lure body and then shrunk to conform to the body.

30. The cover as claimed in claim 26 wherein the cover is made from a film with a reflective surface capable of changing colors according to the incidence of light on the film.

31. The cover as claimed in claim 26 wherein the cover is decorated.

32. The cover as claimed in claim 26 wherein the cover has a printed design bearing fish-like or bait-like features.
